(19) United States
(12) Patent Application Publication
(10) Pub. No.: US 2008/0186639 A1
(43) Pub. Date: Aug. 7, 2008

(54) TUNNELING MAGNETIC SENSING ELEMENT AND METHOD FOR PRODUCING SAME

(76) Inventors: Kazumasa Nishimura, Niigata-ken (JP); Ryo Nakabayashi, Niigata-ken (JP); Naoya Hasegawa, Niigata-ken (JP); Masamichi Saito, Niigata-ken (JP); Yosuke Ide, Niigata-ken (JP); Masahiko Ishizone, Niigata-ken (JP)

Correspondence Address: BRINKS HOFER GILSON & LIONE, P.O. BOX 10395, CHICAGO, IL, 60610, US

(21) Appl. No.: 12/026,985

(22) Filed: Feb. 6, 2008

(30) Foreign Application Priority Data
Feb. 6, 2007 (JP) 2007-027142

(51) Int. Cl. G11B 5/127

(52) U.S. Cl. 360/324.2

(57) ABSTRACT

A tunneling magnetic sensing element includes a pinned magnetic layer with a magnetization direction that is pinned in one direction, an insulating barrier layer, and a free magnetic layer with a magnetization direction that varies in response to an external magnetic field. The insulating barrier layer comprises magnesium (Mg), and a first protective layer composed of Mg is disposed on the free magnetic layer.

This application claims priority to the Japanese Patent Application No. 2007-027142, filed Feb. 6, 2007, the entirety of which is hereby incorporated by reference.

### FIELD

The present disclosure relates to magnetic sensing elements utilizing the tunnel effect mounted in magnetic reproducers, such as hard disk drives, and other magnetic sensors. In particular, the present disclosure relates to a tunneling magnetic sensing element having a high rate of change in resistance (ΔR/R) and a high magnetic sensitivity, and a method for producing the tunneling magnetic sensing element.

### BACKGROUND

Tunneling magnetic sensing elements (tunneling magnetoresistive elements) exhibits a change in resistance due to the tunneling effect. When the magnetization direction of a pinned magnetic layer is antiparallel to that of a free magnetic layer, a tunneling current does not easily flow through an insulating barrier layer (tunnel barrier layer) between the pinned magnetic layer and the free magnetic layer; hence, the resistance is maximized. On the other hand, when the magnetization direction of the pinned magnetic layer is parallel to that of the free magnetic layer, the tunneling current flows easily; hence, the resistance is minimized.

A change in electrical resistance due to a change in the magnetization of the free magnetic layer affected by an external magnetic field is detected as a change in voltage on the basis of this principle to detect a leakage field from a recording medium.

Japanese Unexamined Patent Application Publication No. 2005-109378 (Patent Document 1) discloses a magnetoresistive element. Japanese Unexamined Patent Application Publication No. 2006-5356 (Patent Document 2) discloses a tunneling magnetic sensing element.

In tunneling magnetic sensing elements, in order to improve characteristics of read heads, it is necessary to obtain a high rate of change in resistance (ΔR/R) to increase sensitivity. To increase the rate of change in resistance (ΔR/R) of tunneling magnetic sensing elements, it has been found that the composition of a free magnetic layer or a pinned magnetic layer is preferably changed. For example, a material having a high spin polarizability is preferably disposed at an interface with an insulating barrier layer.

However, a change in the composition of the free magnetic layer or the pinned magnetic layer also changes other magnetic characteristics. Thus, it is desirable to achieve a high rate of change in resistance (ΔR/R) without changing the composition or thickness of the free magnetic layer or the pinned magnetic layer.

In a tunneling magnetic sensing element, proper crystal structures of an insulating barrier layer and a free magnetic layer are important for the improvement of the rate of change in resistance (ΔR/R). For example, in the case of the insulating barrier layer composed of magnesium oxide (Mg—O) or a laminate with a Mg sublayer and a Mg—O sublayer, it has been found that the crystal structure of the free magnetic layer in contact with the insulating barrier layer is preferably a body-centered cubic (bcc) structure in order to increase the rate of change in resistance (ΔR/R) of the tunneling magnetic sensing element.

In this case, if a protective layer, composed of tantalum (Ta), for antioxidation is formed on the free magnetic layer, Ta in the protective layer diffuses into the free magnetic layer and then into the insulating barrier layer during heat treatment in the production process, thereby inhibiting crystallization of the free magnetic layer and the insulating barrier layer. As a result, the free magnetic layer and the insulating barrier layer have distorted bcc structures. Thus, a high rate of change in resistance (ΔR/R) is not obtained.

Also in the case of the protective layer composed of titanium (Ti) or aluminum (Al), Ti or Al in the protective layer diffuse into the free magnetic layer and then the insulating barrier layer as well as Ta and affect the characteristics of the element. In this case, when the insulating barrier layer is composed of Mg—O or a laminate with a Mg sublayer and a Mg—O sublayer, the diffusion of Ti or Al reduces the characteristics of the element. If the insulating barrier layer is composed of Ti—O or Al—O containing the same constituent as the protective layer, the influence of diffusion of Ti or Al is small. If the protective layer is composed of Mg, the diffusion of Mg in the protective layer into the free magnetic layer and the insulating barrier layer reduces the characteristics of the element when the insulating barrier layer is composed of Ti—O or Al—O. It is thus reasoned that in the case where the protective layer is composed of the same element as that contained in the insulating barrier layer, the diffusion of the constituent of the protective layer into the insulating barrier layer has less influence on the insulating barrier layer, so that the characteristics of the element is not easily reduced.

A magnetoresistive element disclosed in Patent Document 1 has a high rate of change in resistance (ΔR/R) by providing a spin filter layer, composed of a nonmagnetic metal, disposed between a free magnetic layer and a protective layer. However, no tunneling magnetic sensing element is described in Patent Document 1. That is, Patent Document 1 does not describe the structure of the protective layer on the free magnetic layer in order to achieve proper crystal structures of the insulating barrier layer and the free magnetic layer of the tunneling magnetic sensing element.

In a tunneling magnetic sensing element described in Patent Document 2, a protective layer disposed on a free magnetic layer has a laminated structure with a ruthenium (Ru) sublayer and a tantalum (Ta) sublayer. This results in a high rate of change in resistance (ΔR/R) without an increase in magnetostriction λ. Patent Document 2 also discloses that the arrangement of an inter-diffusion barrier layer composed of Ru disposed on the free magnetic layer inhibits the diffusion of Ta constituting the protective layer into the free magnetic layer. However, Patent Document 2 does not describe the optimization of crystal structures of the insulating barrier layer and the free magnetic layer in order to increase the rate of change in resistance (ΔR/R) of the tunneling magnetic sensing element.

### SUMMARY

In one aspect, a tunneling magnetic sensing element includes a pinned magnetic layer with a magnetization direction that is pinned in one direction, an insulating barrier layer, and a free magnetic layer with a magnetization direction that varies in response to an external magnetic field. The insulating barrier layer comprises magnesium (Mg), and a first protective layer composed of Mg is disposed on the free magnetic layer.

In another aspect, a method for producing a tunneling magnetic sensing element includes:

(a) a step of forming a pinned magnetic layer and forming an insulating barrier layer that comprises magnesium (Mg) on the pinned magnetic layer;

(b) a step of forming a free magnetic layer on the insulating barrier layer; and

(c) a step of forming a first protective layer composed of Mg on the free magnetic layer.

### BRIEF DESCRIPTION OF THE DRAWINGS

FIG. 1 is a cross-sectional view of a tunneling magnetic sensing element according to an embodiment, the view being taken along a plane parallel to a face facing a recording medium;

FIG. 2 is a process drawing of a method for producing a tunneling magnetic sensing element according to an embodiment (cross-sectional view of the tunneling magnetic sensing element during the production process, the view being taken along a plane parallel to a face facing a recording medium);

FIG. 3 is a process drawing illustrating a step subsequent to the step shown in FIG. 2 (cross-sectional view of the tunneling magnetic sensing element during the production process, the view being taken along a plane parallel to a face facing a recording medium);

FIG. 4 is a process drawing illustrating a step subsequent to the step shown in FIG. 3 (cross-sectional view of the tunneling magnetic sensing element during the production process, the view being taken along a plane parallel to a face facing a recording medium);

FIG. 5 is a graph illustrating the relationship between RA (element resistance R×element area A) and ΔR/R (the rate of change in resistance) of a tunneling magnetic sensing element in each of Example 1 in which a first protective sublayer is formed and Comparative Example 1 in which a first protective sublayer is not formed; and

FIG. 6 is a graph illustrating magnetic moment (Ms·t) per unit area of a free magnetic layer of a tunneling magnetic sensing element in Example 1 in which a first protective sublayer is formed and Comparative Example 1 in which a first protective sublayer is not formed.

### DETAILED DESCRIPTION

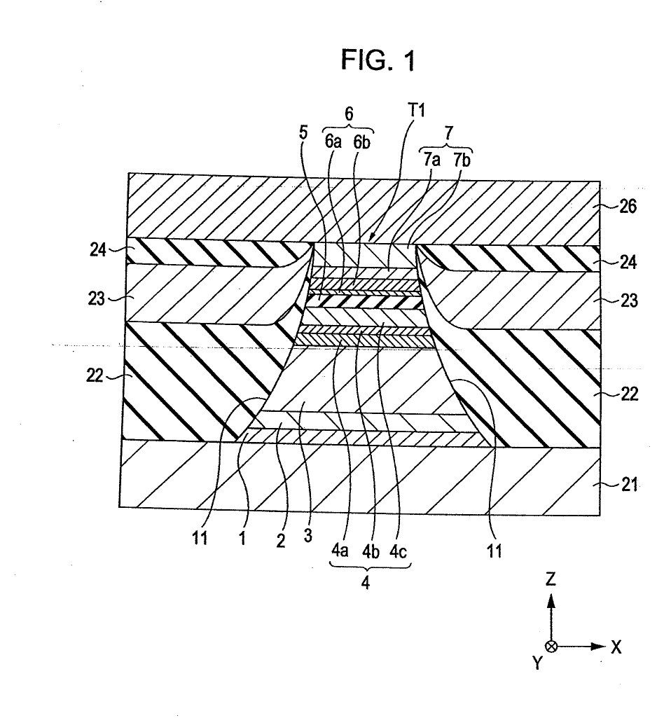

FIG. 1 is a cross-sectional view of a tunneling magnetic sensing element (tunneling magnetoresistive element) according to an embodiment, the view being taken along a plane parallel to a face facing a recording medium.

The tunneling magnetic sensing element is mounted on a trailing end of a floating slider included in a hard disk drive and detects a recording magnetic field from a hard disk or the like. In each drawing, the X direction indicates a track width direction. The Y direction indicates the direction of a magnetic leakage field from a magnetic recording medium (height direction). The Z direction indicates the direction of motion of a magnetic recording medium such as a hard disk and also indicates the stacking direction of layers in the tunneling magnetic sensing element.

In FIG. 1, the lowermost layer is a bottom shield layer 21 composed of, for example, a Ni—Fe alloy. A laminate T1 is arranged on the bottom shield layer 21. The tunneling magnetic sensing element includes the laminate T1, lower insulating layers 22, hard bias layers 23, and upper insulating layers 24 arranged on both sides of the laminate T1 in the track width direction (X direction in the figure).

The lowermost layer of the laminate Ti is an underlying layer 1 composed of at least one nonmagnetic element selected from Ta, Hf, Nb, Zr, Ti, Mo, and W. The underlying layer 1 is overlaid with a seed layer 2. The seed layer 2 is composed of NiFeCr or Cr. The seed layer 2 composed of NiFeCr has a face-centered cubic (fcc) structure. In this case, the preferred orientation of equivalent crystal planes each typically expressed as the {100} plane is achieved in the plane parallel to the layer surfaces. Alternatively, the seed layer 2 composed of Cr has a body-centered cubic (bcc) structure. In this case, the preferred orientation of equivalent crystal planes each typically expressed as the {110} plane is achieved in the plane parallel to the layer surfaces. The underlying layer 1 need not necessarily be formed.

The seed layer 2 is overlaid with an antiferromagnetic layer 3. The antiferromagnetic layer 3 is preferably composed of an antiferromagnetic material containing Mn and an element X that is at least one element selected from Pt, Pd, Ir, Rh, Ru, and Os.

The X-Mn alloy containing the element X of the platinum group has excellent characteristics as an antiferromagnetic material, e.g., satisfactory corrosion resistance, a high blocking temperature, and a high exchange coupling magnetic field (Hex).

Alternatively, the antiferromagnetic layer 3 may be composed of an antiferromagnetic material containing Mn, the element X, and an element X′ that is at least one element selected from Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb and rare-earth elements.

The antiferromagnetic layer 3 is overlaid with a pinned magnetic layer 4. The pinned magnetic layer 4 has a multilayered ferrimagnetic structure including a first pinned magnetic sublayer 4a, a nonmagnetic intermediate sublayer 4b, and a second pinned magnetic sublayer 4c, formed in that order from the bottom. The magnetization direction of the first pinned magnetic sublayer 4a is antiparallel to that of the second pinned magnetic sublayer 4c because of the presence of an exchange coupling magnetic field at the interface between the antiferromagnetic layer 3 and the pinned magnetic layer 4 and an antiferromagnetic exchange coupling magnetic field (RKKY interaction) via the nonmagnetic intermediate sublayer 4b. The multilayered ferrimagnetic structure of the pinned magnetic layer 4 results in stable magnetization of the pinned magnetic layer 4 and apparently increases the exchange coupling magnetic field generated at the interface between the pinned magnetic layer 4 and the antiferromagnetic layer 3. The first pinned magnetic sublayer 4a and the second pinned magnetic sublayer 4c each have a thickness of about 10 to 34 Å. The nonmagnetic intermediate sublayer 4b has a thickness of about 8 to 10 Å.

The first pinned magnetic sublayer 4a is composed of a ferromagnetic material, for example, CoFe, NiFe, or CoFeNi. The nonmagnetic intermediate sublayer 4b is composed of a nonmagnetic conductive material, for example, Ru, Rh, Ir, Cr, Re, or Cu. The second pinned magnetic sublayer 4c is composed of a ferromagnetic material similar to that of the first pinned magnetic sublayer 4a or CoFeB.

The pinned magnetic layer 4 is overlaid with an insulating barrier layer 5. The insulating barrier layer 5 contains magnesium (Mg) and is preferably composed of magnesium oxide (Mg—O), titanium-magnesium oxide (Mg—Ti—O), or the like. In the case of the insulating barrier layer 5 composed of Mg—O, the Mg content of Mg—O is preferably in the range of about 40 to 60 atomic %. The most preferred composition is Mg_{50at%}O_{50at%}. Alternatively, the insulating barrier layer 5 may have a laminate structure with a Mg sublayer and a Mg—O sublayer. The insulating barrier layer 5 is formed by sputtering with a target composed of Mg, Mg—O, or Mg—Ti—O. In the case of the insulating barrier layer 5 composed of Mg—O or Mg—Ti—O, preferably, after a Mg or Ti metal film having a thickness of about 1 to 10 Åis formed, oxidation is performed to form a metal oxide of Mg—O or Mg—Ti—O. In this case, the oxidation results in the metal oxide film having a thickness larger than that of the Mg or Ti metal film formed by sputtering. The insulating barrier layer 5 preferably has a thickness of about 1 to 20 Å. If the insulating barrier layer 5 has an excessively large thickness, a tunneling current does not easily flow, which is not preferred.

The insulating barrier layer 5 is overlaid with a free magnetic layer 6. The free magnetic layer 6 includes a soft magnetic sublayer 6b composed of a magnetic material, such as a NiFe alloy, and an enhancement sublayer 6a, composed of a CoFe alloy or the like, disposed between the soft magnetic sublayer 6b and the insulating barrier layer 5. The soft magnetic sublayer 6b is preferably composed of a magnetic material having excellent soft magnetic characteristics. The enhancement sublayer 6a is preferably composed of a magnetic material having a spin polarizability higher than that of the soft magnetic sublayer 6b. In the case of the soft magnetic sublayer 6b composed of a NiFe alloy, the Ni content is preferably in the range of about 81.5 to 100 atomic % from the viewpoint of magnetic characteristics.

The enhancement sublayer 6a composed of a CoFe alloy having a high spin polarizability improves the rate of change in resistance (ΔR/R). In particular, a CoFe alloy with a high Fe content has high spin polarizability and has thus a high effect of improving the rate of change in resistance (ΔR/R) of the element. The Fe content of the CoFe alloy may be in the range of about 10 to 100 atomic %, without limitation.

An excessively large thickness of the enhancement sublayer 6a affects the magnetic sensitivity of the soft magnetic sublayer 6b and leads to a reduction in sensitivity. Thus, the enhancement sublayer 6a has a thickness smaller than that of the soft magnetic sublayer 6b. The soft magnetic sublayer 6b has a thickness of, for example, about 30 to 70 Å. The enhancement sublayer 6a has a thickness of about 10 Å, preferably about 6 to 20 Å.

The free magnetic layer 6 may have a multilayered ferrimagnetic structure in which a plurality of magnetic sublayers are stacked with a nonmagnetic intermediate sublayer. A track width Tw is determined by the width of the free magnetic layer 6 in the track width direction (X direction in the figure). The free magnetic layer 6 is overlaid with a protective layer 7.

As described above, the laminate T1 is provided on the bottom shield layer 21. Both end faces 11 of the laminate T1 in the track width direction (X direction in the figure) are inclined planes such that the width of the laminate T1 in the track width direction is gradually reduced with height.

As shown in FIG. 1, the lower insulating layers 22 are disposed on the bottom shield layer 21 that extends toward both sides of the laminate T1 and disposed on the end faces 11 of the laminate T1. The hard bias layers 23 are disposed on the lower insulating layers 22. The upper insulating layers 24 are disposed on the hard bias layers 23.

Bias underlying layers (not shown) may be disposed between the lower insulating layers 22 and the hard bias layers 23. The bias underlying layers are each composed of, for example, Cr, W, or Ti.

The lower and upper insulating layers 22 and 24 are each composed of an insulating material, such as Al₂O₃ or SiO₂. The lower and upper insulating layers 22 and 24 insulate the hard bias layers 23 in such a manner that a current flowing through the laminate T1 in the direction perpendicular to interfaces between the layers is not diverted to both sides of the laminate T1 in the track width direction. The hard bias layers 23 are each composed of, for example, a Co—Pt (cobalt-platinum) alloy or a Co—Cr—Pt (cobalt-chromium-platinum) alloy.

The laminate T1 and the upper insulating layers 24 are overlaid with a top shield layer 26 composed of, for example, a NiFe alloy.

In the embodiment shown in FIG. 1, the bottom shield layer 21 and the top shield layer 26 each function as an electrode layer. A current flows in the direction perpendicular to surfaces of the layers of the laminate T1 (in the direction parallel to the Z direction in the figure).

A bias magnetic field from the hard bias layers 23 is applied to the free magnetic layer 6 to magnetize the free magnetic layer 6 in the direction parallel to the track width direction (X direction in the figure). On the other hand, the first pinned magnetic sublayer 4a and the second pinned magnetic sublayer 4c constituting the pinned magnetic layer 4 are magnetized in the direction parallel to the height direction (Y direction in the figure). Since the pinned magnetic layer 4 has a multilayered ferrimagnetic structure, the magnetization direction of the first pinned magnetic sublayer 4a is antiparallel to that of the second pinned magnetic sublayer 4c. The magnetization direction of the pinned magnetic layer 4 is pinned, i.e., the magnetization direction is not changed by an external magnetic field. The magnetization direction of the free magnetic layer 6 varies in response to the external magnetic field.

In the case where the magnetization direction of the free magnetic layer 6 is changed by the external magnetic field, when the magnetization direction of the second pinned magnetic sublayer 4c is antiparallel to that of the free magnetic layer 6, a tunneling current does not easily flow through the insulating barrier layer 5 disposed between the second pinned magnetic sublayer 4c and the free magnetic layer 6 to maximize a resistance. On the other hand, when the magnetization direction of the second pinned magnetic sublayer 4c is parallel to that of the free magnetic layer 6, the tunneling current flows easily to minimize the resistance.

On the basis of this principle, a change in electric resistance due to a change in the magnetization of the free magnetic layer 6 affected by the external magnetic field is converted into a change in voltage to detect a leakage magnetic field from a magnetic recording medium.

A tunneling magnetic sensing element according to this embodiment includes a first protective sublayer 7a composed of magnesium (Mg) on the free magnetic layer 6.

This results in an increase in the rate of change in resistance (ΔR/R). In this case, the composition and the thickness of the free magnetic layer 6 are not changed; hence, other magnetic characteristics are not changed.

The first protective sublayer 7a is formed on the free magnetic layer 6 by sputtering with Mg. The first protective sublayer 7a preferably has a thickness of about 5 to 200 Å and more preferably about 10 to 200 Å.

The first protective sublayer 7a having a thickness of less than about 5 Å does not appropriately inhibit the diffusion of the element constituting a second protective sublayer 7b disposed on the first protective sublayer 7a into the free magnetic layer 6 and the insulating barrier layer 5. A structure in which the protective layer 7 is made of the first protective sublayer 7a alone is also included in this embodiment. In this case, the first protective sublayer 7a having a thickness of less than about 5 Å has a low antioxidative effect, which is not preferred. Thus, the first protective sublayer 7a preferably has a thickness of about 5 Å or more.

In this embodiment, the free magnetic layer 6 preferably has a laminated structure with the enhancement sublayer 6a and the soft magnetic sublayer 6b. The enhancement sublayer 6a is composed of a CoFe alloy and a spin polarizability higher than that of the soft magnetic sublayer 6b, thereby improving the rate of change in resistance (ΔR/R). Hitherto, the arrangement of the enhancement sublayer 6a between the insulating barrier layer 5 and the soft magnetic sublayer 6b has resulted in improvement in the rate of change in resistance (ΔR/R). To further improve the rate of change in resistance (ΔR/R), the optimization of the composition and the like of the enhancement sublayer 6a has been required. In this case, other magnetic characteristics are disadvantageously changed (e.g., an increase in magnetostriction λ). In contrast, in this embodiment, the first protective sublayer 7a composed of Mg is provided on the free magnetic layer 6 without changing the composition of, in particular, the enhancement sublayer 6a and the rest of the structure of the free magnetic layer 6; hence, the rate of change in resistance (ΔR/R) is effectively improved without changing other magnetic characteristics.

A structure in which the protective layer 7 is made of only the first protective sublayer 7a composed of Mg is included in this embodiment. Preferably, the second protective sublayer 7b is formed on the first protective sublayer 7a, as shown in FIG. 1. In the case where the first protective sublayer 7a composed of Mg has a small thickness, the arrangement of the second protective sublayer 7b on the first protective sublayer 7a results in the protective layer 7 having a large thickness, thereby appropriately preventing oxidation of the laminate under the protective layer 7. Furthermore, another protective layer may be disposed on the second protective sublayer 7b.

In the case where the protective layer 7 includes a two or more sublayers, the first protective sublayer 7a composed of Mg is disposed so as to be in contact with the free magnetic layer 6. This prevents interdiffusion of constituents between the free magnetic layer 6 and the second protective sublayer 7b and enhances the effect of improving the rate of change in resistance (ΔR/R).

The second protective sublayer 7b may be composed of a metal, such as Ta, Ti, Al, Cu, Cr, Fe, Ni, Mn, Co, or V, or oxides or nitrides thereof, wherein the metal conventionally has been used for a protective layer.

The second protective sublayer 7b is preferably composed of Ta or the like from the viewpoint of low electric resistance and mechanical protection. Ta is readily oxidized and thus has a role to adsorb oxygen in the laminated structure. Therefore, if oxygen is contaminated in the first protective sublayer 7a composed of Mg, oxygen is attracted to the second protective sublayer 7b. In this way, the influence of oxidation on the free magnetic layer 6 is inhibited.

Ta diffuses readily by heat. In the case where the protective layer 7 is a single second protective sublayer 7b composed of Ta without the first protective sublayer 7a composed of Mg, Ta in the second protective sublayer 7b diffuses into the free magnetic layer 6 and then insulating barrier layer 5 during heat treatment in the production process, thus inhibiting the crystallization of the free magnetic layer 6 and the insulating barrier layer 5. In particular, in a tunneling magnetic sensing element including the insulating barrier layer 5 composed of magnesium oxide (Mg—O) or a laminate with a Mg sublayer and a Mg—O sublayer, it has been found that the free magnetic layer 6, in particular, the enhancement sublayer 6a in contact with the insulating barrier layer 5 having a body-centered cubic (bcc) structure has a high rate of change in resistance (ΔR/R). However, in the case of the protective layer 7 composed of Ta alone, the inhibition of the crystallization of the free magnetic layer 6 and the insulating barrier layer 5 due to the diffusion of Ta results in distorted bcc structures. Thereby, a high rate of change in resistance (ΔR/R) is not obtained.

In the tunneling magnetic sensing element according to this embodiment, the arrangement of the first protective sublayer 7a composed of Mg between the free magnetic layer 6 and the second protective sublayer 7b composed of Ta prevents the diffusion of Ta into the free magnetic layer 6 and the insulating barrier layer 5 and improves the crystallinity of the free magnetic layer 6. In this embodiment, therefore, a high rate of change in resistance (ΔR/R) is obtained compared with that in the related art. In particular, in the tunneling magnetic sensing element including the insulating barrier layer 5 composed of magnesium oxide (Mg—O) or a laminate with a Mg sublayer and a Mg—O sublayer, the bcc structures of the free magnetic layer 6 and the insulating barrier layer 5 are satisfactorily maintained; hence, a high rate of change in resistance (ΔR/R) is obtained.

Mg constituting the first protective sublayer 7a can diffuse into the free magnetic layer 6 and the insulating barrier layer 5 during heat treatment in the production process. The insulating barrier layer 5 is composed of magnesium oxide (Mg—O) or a laminate with a Mg sublayer and a Mg—O sublayer. That is, the insulating barrier layer 5 contains Mg. Thus, even when Mg diffuses into the insulating barrier layer 5, the diffusion has less influence on the characteristics of the insulating barrier layer 5 because the insulating barrier layer 5 contains Mg. This may contribute to an increase in the rate of change in resistance (ΔR/R). Therefore, the protective layer 7 preferably has the same constituent as that of the insulating barrier layer 5 in order to obtain a high rate of change in resistance (ΔR/R). The diffusion of the constituent of the protective layer 7 has less influence on the insulating barrier layer 5. Thus, the diffusion also has less influence on the characteristics of the element, thereby suppressing the degradation of the element.

Also in the case where the second protective sublayer 7b is disposed, the first protective sublayer 7a may have a thickness of about 5 to 200 Å. The first protective sublayer 7a may have a thickness smaller than that in the case where the protective layer 7 is made of a first protective sublayer 7a alone. The second protective sublayer 7b may have a thickness smaller or larger than that of the first protective sublayer 7a. The thickness of the entire protective layer 7 is in the range of about 100 to 300 Å.

In this embodiment, in the case of the insulating barrier layer 5 composed of Mg—O or a laminate with a Mg sublayer and a Mg—O sublayer, preferably, the second pinned magnetic sublayer 4c is composed of CoFeB and has an amorphous structure. This results in the insulating barrier layer 5 having the bcc structure and the enhancement sublayer 6a, having the bcc structure, on the insulating barrier layer 5.

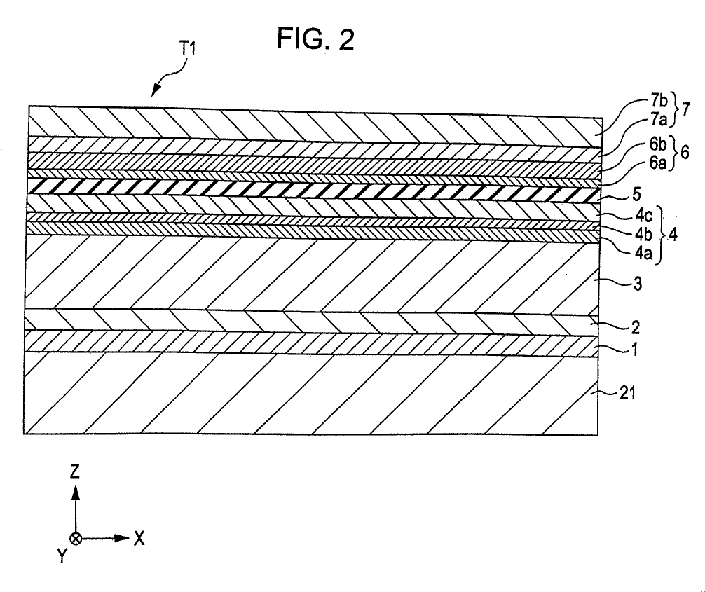

A method for producing a tunneling magnetic sensing element according to this embodiment will be described below. FIGS. 2 to 4 are fragmentary cross-sectional views of a tunneling magnetic sensing element during a production process, the view being taken along the same plane as in FIG. 1.

In a step shown in FIG. 2, the underlying layer 1, the seed layer 2, the antiferromagnetic layer 3, the first pinned magnetic sublayer 4a, the nonmagnetic intermediate sublayer 4b, and the second pinned magnetic sublayer 4c are successively formed on the bottom shield layer 21.

The insulating barrier layer 5 is formed by sputtering on the second pinned magnetic sublayer 4c. Alternatively, after a metal layer is formed by sputtering, the metal layer is oxidized by introducing oxygen into a vacuum chamber to form the insulating barrier layer 5. A semiconductor layer may be formed in place of the metal layer. The metal layer or the semiconductor layer is oxidized to increase the thickness thereof. Thus, the metal layer or the semiconductor layer is formed in such a manner that the thickness after oxidation is equal to the thickness of the insulating barrier layer 5. Examples of oxidation include radical oxidation, ion oxidation, plasma oxidization, and natural oxidation.

In this embodiment, the insulating barrier layer 5 is preferably composed of magnesium oxide (Mg—O). In this case, the insulating barrier layer 5 composed of Mg—O is formed on the second pinned magnetic sublayer 4c by sputtering with a target composed of Mg—O having a predetermined composition. Alternatively, after formation of a Mg layer by sputtering, the Mg layer may be oxidized. The insulating barrier layer 5 may be composed of a laminate with a Mg sublayer and a Mg—O sublayer. In this case, after formation of the Mg sublayer on the second pinned magnetic sublayer 4c by sputtering, the Mg—O sublayer is formed by sputtering to form the laminate with the Mg sublayer and the Mg—O sublayer. Furthermore, the formation of a Mg sublayer by sputtering and the formation of a Mg—O sublayer by sputtering may be repeated. The insulating barrier layer 5 may also be composed of titanium-magnesium oxide (Mg—Ti—O).

The free magnetic layer 6 including the enhancement sublayer 6a composed of CoFe and the soft magnetic sublayer 6b composed of NiFe is formed on the insulating barrier layer 5. The first protective sublayer 7a composed of Mg is formed on the free magnetic layer 6. The second protective sublayer 7b composed of Ta or the like is formed. Thereby, the laminate T1 including the underlying layer 1 to the protective layer 7 stacked in sequence is formed.

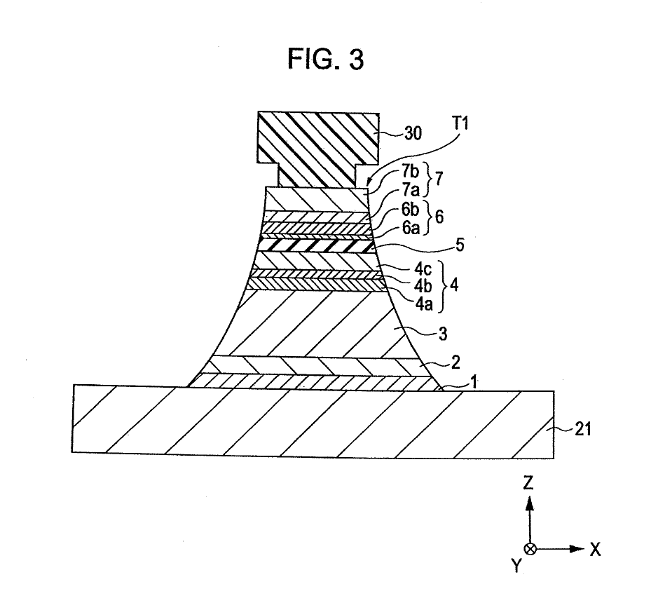

A resist layer 30 used in a lift-off process is formed on the laminate T1. Referring to FIG. 3, both sides of the laminate T1 in the track width direction (X direction in the figure) which are not covered with the resist layer 30 are removed by etching or the like.

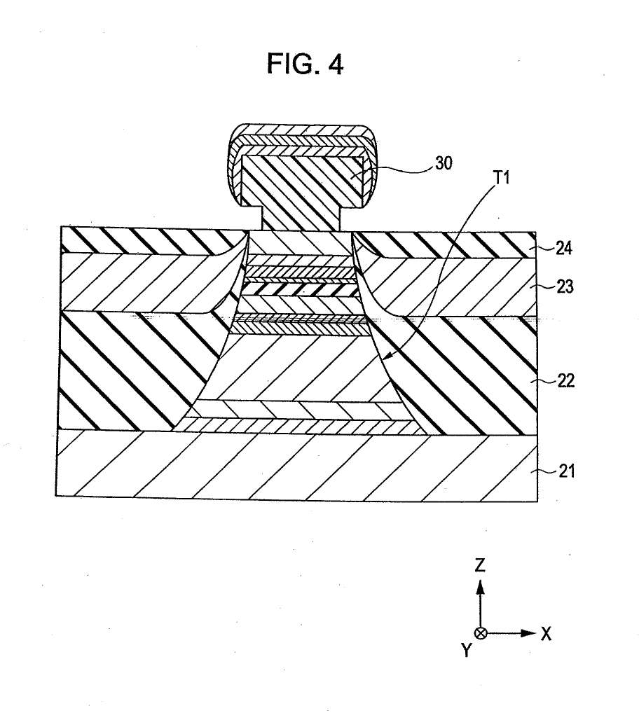

Referring to FIG. 4, the lower insulating layers 22, the hard bias layers 23, and the upper insulating layers 24 are stacked in that order from the bottom on both sides of the laminate Ti in the track width direction (X direction in the figure) and on the bottom shield layer 21.

The resist layer 30 is removed by the lift-off process. The top shield layer 26 is formed on the laminate T1 and the upper insulating layers 24.

The method for producing the tunneling magnetic sensing element includes annealing. An example of typical annealing is annealing in a magnetic field to generate the exchange coupling magnetic field (Hex) between the antiferromagnetic layer 3 and the first pinned magnetic sublayer 4a. Annealing is performed at a temperature in the range of about 240° C. to 310° C.

In this embodiment, the arrangement of the first protective sublayer 7a composed of Mg directly on the free magnetic layer 6 inhibits the diffusion of the constituent element, such as Ta, of the second protective sublayer 7b into the free magnetic layer 6 and the insulating barrier layer 5 during the above-described annealing in the magnetic field or another annealing, and improves the crystallinity of the free magnetic layer 6.

Thereby, the tunneling magnetic sensing element having an effectively improved rate of change in resistance (ΔR/R) is produced simply and appropriately without changing the composition and thickness of the free magnetic layer 6 or other magnetic characteristics.

In this embodiment, the tunneling magnetic sensing element can be used not only in hard disk drives but also as magnetoresistive random-access memory (MRAM) and a magnetic sensor.

### EXAMPLE 1

A tunneling magnetic sensing element as shown in FIG. 1 was formed.

A laminate T1 was formed so as to have the following structure: underlying layer 1; Ta (80)/seed layer 2; Ni_{49at%}Fe_{12at%}Cr_{39at%} (50)/antiferromagnetic layer 3; Ir_{26at%}Mn_{74at%} (70)/pinned magnetic layer 4 [first pinned magnetic sublayer 4a; Co_{70at%}Fe_{30at%} (14)/nonmagnetic intermediate sublayer 4b; Ru (9.1)/second pinned magnetic sublayer 4c; Co_{40at%}Fe_{40at%}B_{20at%} (18)]/insulating barrier layer 5; MgO (12)/free magnetic layer 6 [enhancement sublayer 6a; Co_{50at%}Fe_{50at%} (10)/soft magnetic sublayer 6b; Ni_{87at%}Fe_{13at%} (50)]/protective layer 7 [first protective sublayer; Mg (20)/second protective sublayer; Ta (180)], stacked in that order from the bottom. Each of the values in parentheses indicates an average thickness (unit: Å). After formation of the laminate T1, the laminate T1 was subjected to annealing at about 270° C. for about three hours and 30 minutes (Example 1).

A tunneling magnetic sensing element was formed as in Example 1, except that the first protective sublayer 7a was not formed and that the protective layer 7 was made of a single Ta layer (about 200 Å) (Comparative Example 1).

For each of the tunneling magnetic sensing elements in Example 1 and Comparative Example 1, the rate of change in resistance (ΔR/R), element resistance R×element area A (RA), and the magnetostriction λ and the magnetic moment (Ms·t) per unit area of the free magnetic layer 6 were measured. Table 1 shows the results.

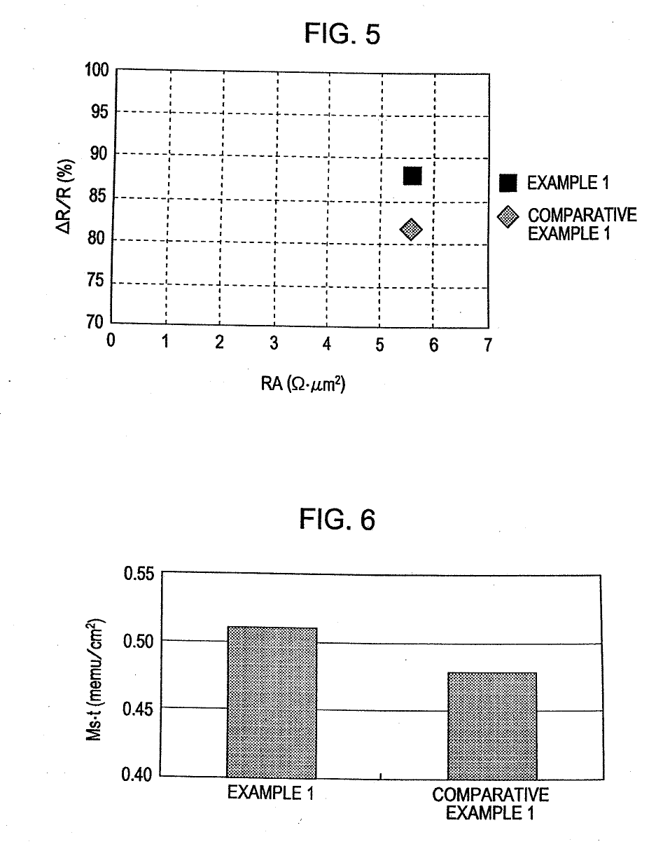

On the basis of the results shown in Table 1, FIG. 5 is a graph illustrating the relationship between RA and the rate of change in resistance (ΔR/R). FIG. 6 is a graph illustrating magnetic moment (Ms·t) per unit area of the free magnetic layer in each of Example 1 and Comparative Example 1.

TABLE 1

| | First | Second | | | | |
|---|---|---|---|---|---|---|
| | protective | protective | RA | | Magneto- | Ms · t |
| | sublayer | sublayer | (Ω · | ΔR/R | striction | (memu/ |
| | (thickness) | (thickness) | μm²) | (%) | (ppm) | cm²) |
| Example 1 | Mg (20 Å) | Ta (180 Å) | 5.6 | 88.0 | 8.3 | 0.51 |
| Compar- | — | Ta (200 Å) | 5.6 | 81.9 | 5.5 | 0.48 |
| ative | | | | | | |
| Example 1 | | | | | | |

The results shown in Table 1 and FIG. 5 demonstrated that the tunneling magnetic sensing element including the protective layer 7 having the laminated structure with the first protective sublayer 7a composed of Mg and the second protective sublayer 7b composed of Ta in Example 1 had an improved rate of change in resistance (ΔR/R) compared with that of the tunneling magnetic sensing element including the protective layer 7 composed of Ta alone in Comparative Example 1.

In a tunneling magnetic sensing element, a higher RA (element resistance R×element area A) does not provide high recording density. Thus, preferably, a high rate of change in resistance (ΔR/R) is obtained at a low RA level. As shown in FIG. 5, RA in Example 1 was substantially the same as that in Comparative Example 1. The results demonstrated that the arrangement of the first protective sublayer 7a composed of Mg did not affect RA.

The results shown in Table 1 and FIG. 6 demonstrated that the magnetic moment (Ms·t) per unit area in Example 1 was higher than that in Comparative Example 1. This may be because the arrangement of the first protective sublayer composed of Mg between the free magnetic layer and the second protective sublayer composed of Ta inhibited the diffusion of Ta into the free magnetic layer and improved the crystallinity of the free magnetic layer. As shown in Table 1 and FIG. 5, therefore, a high rate of change in resistance (ΔR/R) in Example 1 was obtained compared with that in Comparative Example 1.

The first protective sublayer 7a and the insulating barrier layer 5 were composed of Mg. Even when Mg in the first protective sublayer 7a diffused into the insulating barrier layer 5 by heat in the production process, the diffusion had less influence on the composition and characteristics of the insulating barrier layer 5. Thereby, a high rate of change in resistance (ΔR/R) was obtained.

As shown in Table 1, the magnetostriction λ of the free magnetic layer in Example 1 in which the first protective sublayer 7a was composed of Mg was larger than that in Comparative Example 1 in which the protective layer 7 was composed of Ta. However, the amount of increase in magnetostriction was small. Thus, the increase in magnetostriction did not cause noise of a read head or a reduction in the stability of the head.

Tunneling magnetic sensing elements including insulating barrier layers composed of Mg—O and first protective sublayers 7a composed of various materials other than Mg were studied.

Tunneling magnetic sensing elements were formed as in Example 1, except that the first protective sublayers 7a were composed of Al, Ti, Ru, Pt, and Cr (Comparative Examples 2 to 6). The rate of change in resistance (ΔR/R) and RA (element resistance R×element area A) of each of the resulting elements were measured. Table 2 shows the results. The term “ΔR/R ratio” in Table 2 refers to the ratio of ΔR/R of each of Example and Comparative Examples to ΔR/R of Comparative Example 1 in which the first protective sublayer 7a is composed of Ta without formation of the first protective sublayer 7a.

TABLE 2

| | First | Second | | | |
|---|---|---|---|---|---|
| | protective | protective | | | |
| | sublayer | sublayer | RA | ΔR/R | |
| | (thickness) | (thickness) | (Ω · μm²) | (%) | ΔR/R ratio |
| Example 1 | Mg (20 Å) | Ta (180 Å) | 5.6 | 88.0 | 1.07 |
| Comparative | — | Ta (200 Å) | 5.6 | 81.9 | 1.00 |
| Example 1 | | | | | |
| Comparative | Al (20 Å) | Ta (180 Å) | 6.0 | 76.6 | 0.94 |
| Example 2 | | | | | |
| Comparative | Ti (20 Å) | Ta (180 Å) | 6.1 | 78.0 | 0.95 |
| Example 3 | | | | | |
| Comparative | Ru (20 Å) | Ta (180 Å) | 5.8 | 71.9 | 0.88 |
| Example 4 | | | | | |
| Comparative | Pt (20 Å) | Ta (180 Å) | 5.3 | 73.0 | 0.89 |
| Example 5 | | | | | |
| Comparative | Cr (20 Å) | Ta (180 Å) | 5.8 | 58.0 | 0.71 |
| Example 6 | | | | | |

As shown in Table 2, RA in each of Example 1 and Comparative Example 2 to 6 in which the first protective sublayers 7a were composed of Mg, Al, Ti, Ru, Pt, and Cr was substantially comparable to that in Comparative Example 1 in which the protective layer 7 was composed of Ta alone. The rate of change in resistance (ΔR/R) in Example 1 in which the first protective sublayer 7a was composed of Mg was higher than that in Comparative Example 1 in which the protective layer 7 was composed of Ta alone. The rate of change in resistance (ΔR/R) in each of Comparative Examples 2 to 6 in which the first protective sublayers were composed of Al, Ti, Ru, Pt, and Cr was lower than that in Comparative Example 1. The results demonstrated that although the first protective sublayers 7a composed of Mg, Al, Ti, Ru, Pt, and Cr did not affect RA, the first protective sublayer 7a composed of Mg was effective in improving the rate of change in resistance (ΔR/R).

What is claimed is:

1. A tunneling magnetic sensing element comprising:
a pinned magnetic layer with a magnetization direction that is pinned in one direction;
an insulating barrier layer; and
a free magnetic layer with a magnetization direction that varies in response to an external magnetic field,
wherein the insulating barrier layer comprises magnesium (Mg), and a first protective layer composed of Mg is disposed on the free magnetic layer.

2. The tunneling magnetic sensing element according to claim 1, further comprising:
a second protective layer disposed on the first protective layer and composed of tantalum (Ta).

3. The tunneling magnetic sensing element according to claim 1,
wherein the free magnetic layer includes an enhancement sublayer composed of a CoFe alloy and a soft magnetic sublayer composed of a NiFe alloy stacked in that order from the bottom, and
wherein the enhancement sublayer is in contact with the insulating barrier layer, and the soft magnetic sublayer is in contact with the first protective layer.

4. The tunneling magnetic sensing element according to claim 3,
wherein the insulating barrier layer comprises magnesium oxide (Mg—O) or a laminated structure with a Mg sublayer and a Mg—O sublayer, and wherein the enhancement sublayer has a body-centered cubic structure.

5. A method for producing a tunneling magnetic sensing element comprising:
(a) a step of forming a pinned magnetic layer and forming an insulating barrier layer comprising magnesium (Mg) on the pinned magnetic layer;
(b) a step of forming a free magnetic layer on the insulating barrier layer; and
(c) a step of forming a first protective layer composed of Mg on the free magnetic layer.

6. The method according to claim 5,
wherein step (c) further includes after forming the first protective layer, a step of forming a second protective layer comprising tantalum (Ta) on the first protective layer.

7. The method according to claim 5,
wherein in step (a), the insulating barrier layer comprising magnesium oxide (Mg—O) or a laminated structure with a Mg sublayer and a Mg—O sublayer is formed, and wherein in step (b), the free magnetic layer comprising an enhancement layer composed of a CoFe alloy and a soft magnetic sublayer composed of a NiFe alloy, stacked in that order from the bottom, is formed.

8. The method according to claim 5,
wherein annealing is performed after step (c).
